(19) United States
(12) Patent Application Publication
(10) Pub. No.: US 2006/0126614 A1
(43) Pub. Date: Jun. 15, 2006

(54) Automatic network configuration

(75) Inventor: Bryan Mark Logan, Rochester, MN (US)

Correspondence Address: IBM (ROC-BLF), C/O BIGGERS & OHANIAN, LLP, P.O. BOX 1469, AUSTIN, TX, 78767-1469, US

(73) Assignee: International Business Machines Corporation, Armonk, NY (US)

(21) Appl. No.: 11/008,810

(22) Filed: Dec. 9, 2004

(51) Int. Cl. H04L 12/56

(52) U.S. Cl. 370/389

(57) ABSTRACT

Automatic network configuration of a device including receiving a packet and selecting a network address in dependence upon a network address of the packet. In typical embodiments, receiving a packet also includes determining whether the received packet is an ARP query. If the received packet is an ARP query, selecting a network address in dependence upon a network address of the packet may include selecting a possible network address similar to the network address of the source of the packet; and sending an ARP query for the selected possible network address. If an ARP response is returned for the ARP query, embodiments may include selecting another possible network address similar to the network address of the source of the packet. If no ARP response is returned for the ARP query, embodiments may include accepting the possible network address as a network address for the device.

### BACKGROUND OF THE INVENTION

1. Field of the Invention

The field of the invention is data processing, or, more specifically, methods, systems, and products for automatic network configuration.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Today's computers are also often coupled for data communications in networks. To communicate on a network a computer must be configured with a network address. Configuration often requires a system administrator to manually configure the computer either through instruction screens accessible through a user interface attached to the computer or accessible through a network.

Some limited automatic configuration techniques are currently available. Dynamic Host Configuration Protocol “DHCP,” for example, is a protocol for dynamically assigning network addresses to computer devices on a network when the devices are added to the network. With dynamic addressing, a device can have a different address every time the device connects to the network. To obtain an address, a DHCP client device broadcasts a DCHP request on the network requesting a network address. A DHCP server allocates an address to the device and sends a response to the DHCP client informing the device of its assigned address. DHCP doesn't allocate addresses permanently. Each device on the network is assigned an address for a specific time period. Dynamic addressing simplifies network administration because it does not require a system administrator to manage the addressing of devices. DHCP does however require a DHCP server to be available to assign an IP address to a client device when the device connects to the network. DHCP is therefore subject to failure if the DHCP server is not available.

Another automatic configuration technique currently available is Zero Configuration Networking or “ZeroConf”. Zero Conf provides the ZeroConf Multicast Address Allocation Protocol (“ZMAAP”), a peer-to-peer protocol that allocates multicast addresses for devices on a local network. ZeroConf is useful to configure devices on local networks, but such devices are often not available for data communications with devices outside of the local network.

### SUMMARY OF THE INVENTION

Exemplary methods, apparatus, systems, and products are described that expand traditional automatic network configuration that do not require an available DHCP server and facilitate communications outside a local network. That is, methods, apparatus, systems, and computer program products are provided for automatic network configuration of devices that operate generally by receiving, in a device to be configured, a packet and selecting, by the device to be configured, a network address in dependence upon a network address of the packet.

In typical embodiments, receiving, in a device to be configured, a packet also includes determining whether the received packet is an ARP query. If the received packet is an ARP query, in typical embodiments, selecting, by the device to be configured, a network address in dependence upon a network address of the packet includes selecting a possible network address similar to the network address of the source of the packet and sending an ARP query for the selected possible network address. If an ARP response is returned for the ARP query, such embodiments include selecting another possible network address similar to the network address of the source of the packet. If no ARP response is returned for the ARP query, such embodiments include accepting the possible network address as a network address for the device.

If the received packet is not an ARP query, in typical embodiments, selecting, by the device to be configured, a network address in dependence upon a network address of the packet includes sending an ARP query for the source of the packet. If a response is returned to the ARP query for the source of the packet, then embodiments typically include selecting a possible network address similar to a network address of the source of the packet. If no response is returned to the ARP query for the source of the packet, then embodiments typically include selecting a possible network address similar to the destination address of the packet. Embodiments also typically include sending an ARP query for the selected possible network address. If an ARP response is returned for the ARP query for the selected possible network address, such embodiments include selecting another possible network address. If no ARP response is returned for the ARP query for the selected possible network address, such embodiments include accepting the possible network address as a network address for the device.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram that depicts an exemplary data processing system capable of automatic network configuration according to embodiments of the present invention.

FIG. 2 sets forth a block diagram of automated computing machinery comprising a computer capable of automatic network configuration according to embodiments of the present invention.

FIG. 3 sets forth a flow chart illustrating an exemplary method for automatic network configuration of a device according to embodiments of the present invention.

FIG. 4 sets forth a flow chart illustrating further aspects of automatic network configuration.

FIG. 5 sets forth a flow chart illustrating further aspects of automatic network configuration.

FIG. 6 therefore sets forth a flow chart illustrating further aspects of automatic network configuration.

FIG. 7 sets forth an exemplary method for automatic network configuration that determines a network address of a gateway on the network.

FIG. 8 sets forth another method for automatic network configuration of a device that determines a network address of a gateway on the network.

### DETAILED DESCRIPTION OF EXEMPLARY EMBODIMENTS

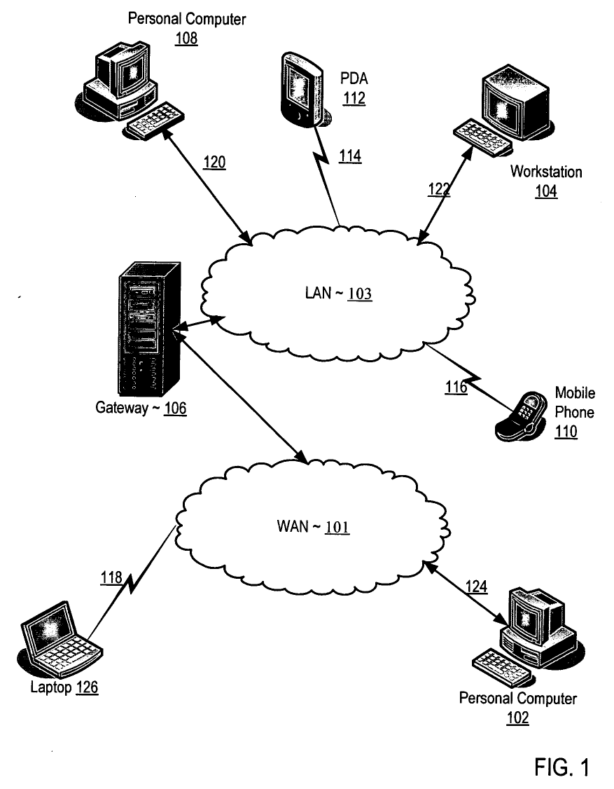

Exemplary methods, apparatus, systems, and products for automatic network configuration of a device are now explained with reference to the accompanying drawings, beginning with FIG. 1. FIG. 1 depicts an exemplary data processing system capable of automatic network configuration according to embodiments of the present invention. The system of FIG. 1 includes a number of computer devices (108, 112, 110, 104, 106, 126, 102) connected for data communications in networks. Each of the devices of the system of FIG. 1 is capable of automatic network configuration according to embodiments of the present invention.

The data processing system of FIG. 1 includes wide area network (“WAN”) (101) and local area network (“LAN”) (103). In the example of FIG. 1, several exemplary devices including a PDA (112), a computer workstation (104), a mobile phone (110), and personal computer (108) are connected to the LAN (103). The network-enabled mobile phone (110) connects to the LAN (103) through wireless link (116), and the PDA (112) connects to the LAN (103) through wireless link (114). In the example of FIG. 1, personal computer (108) connects through a wireline connection (120) to the LAN (103), and a computer workstation (104) connects through a wireline connection (122) to the LAN (103). In the example of FIG. 1, a laptop (126) connects through a wireless link (118) to the WAN (101), and the personal computer (102) connects through a wireline connection (124) to the WAN (101). The network connection aspect of the architecture of FIG. 1 is only for explanation, not for limitation. In fact, systems for automatic network configuration of a device according to embodiments of the present invention may be connected as LANs, WANs, intranets, internets, the Internet, webs, the World Wide Web itself, or other connections as will occur to those of skill in the art. Such networks are media that may be used to provide data communications connections between various devices and computers connected together within an overall data processing system.

In the example of FIG. 1, a gateway (106) implements data communications between devices (108, 112, 104, and 110) on the LAN (103) and devices (126, 102) on the WAN (101). The gateway of FIG. 1 serves as an entrance for communications between the WAN (101) and the LAN (103). The gateway of FIG. 1 functions as both a router, which uses headers and forwarding tables to determine where packets are sent, and a switch, which provides the actual path for the packet in and out of the gateway.

In the system of FIG. 1, the exemplary devices (108, 112, 104, and 110) on the LAN are capable of automatic network configuration in accordance with the present invention by receiving, in the device to be configured, a packet and selecting, by the device to be configured, a network address in dependence upon a network address of the packet. In this disclosure, a ‘network address’ means a network layer protocol address as defined for example by the International Organization for Standardization (‘ISO’) standard Open System Interconnection (‘OSI’) model. Examples of network layer protocols include Internet Protocol version 4 (“IPv4”), Internet Protocol version 6 (“IPv6”), Internet Control Message Protocol (“ICMP”), Internet Gateway Management Protocol (“IGMP”) and others that will occur to those of skill in the art. The exemplary devices of FIG. 1 are capable of selecting, by the device to be configured, a network address in a number of ways each of which is described in more detail below.

The arrangement of servers and other devices making up the exemplary system illustrated in FIG. 1 is for explanation, not for limitation. Data processing systems useful according to various embodiments of the present invention may include additional servers, routers, hubs, other devices, and peer-to-peer architectures, not shown in FIG. 1, as will occur to those of skill in the art. Networks in such data processing systems may support many data communications protocols, including for example TCP/IP, HTTP, WAP, HDTP, and others as will occur to those of skill in the art. Various embodiments of the present invention may be implemented on a variety of hardware platforms in addition to those illustrated in FIG. 1.

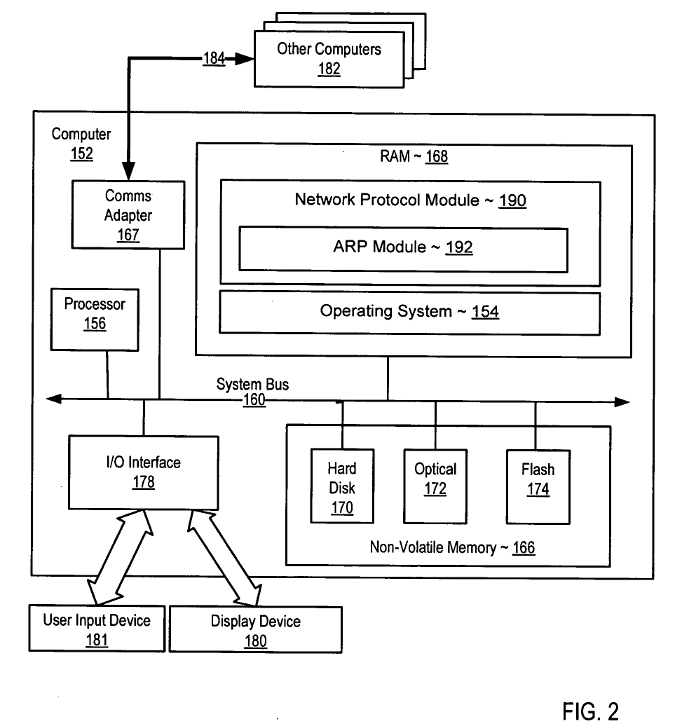

As mentioned above, automatic network configuration implemented with computers, that is, with automated computing machinery. For further explanation, FIG. 2 sets forth a block diagram of a device comprising a computer (152) capable of automatic network configuration according to embodiments of the present invention. The computer (152) of FIG. 2 includes at least one computer processor (156) or ‘CPU’ as well as random access memory (168) (“RAM”). Stored in RAM (168) is an operating system (154). Operating systems useful in computers according to embodiments of the present invention include UNIX™, Linux™, Microsoft Windows NT™, AIX™, IBM's i5/OS™, and many others as will occur to those of skill in the art. Operating system (154) in the example of FIG. 2 is shown in RAM (168), but many components of an operating system typically are stored in non-volatile memory (166) also.

Also stored in RAM (168) is a network protocol module (190) capable of receiving a packet and selecting a network address in dependence upon a network address of the packet. In many embodiments, the packet is intended for another device and is broadcast to all devices on the LAN upon which the device to be configured is connected. In other embodiments, the packet is an ARP query sent by a device on the LAN upon which the device to be configured is connected.

In the example of FIG. 2, the network protocol module includes an ARP module (192) capable of determining whether the received packet is an ARP query. An address resolution protocol (“ARP”) query is a message broadcast to all the devices on a LAN for which a router or other device on the LAN seeks a corresponding link layer address. That is, all devices on the LAN are sent a link layer packet asking for their link layer addresses. The packet includes the sought network layer address. All devices on the LAN discard the ARP query except for the device whose network address matches the network address in the query. The device whose network address matches the network address in the query sends its link layer address to the requesting device.

In this disclosure, the phrase ‘link layer’ means link layer connections as defined for example by the International Organization for Standardization (‘ISO’) standard Open System Interconnection (‘OSI’) model. Examples of link layer connections include Ethernet, 802.11 and others as will occur to those of skill in the art.

If the received packet is an ARP query, the network protocol module is capable of selecting a possible network address similar to the network address of the source of the packet and sending another ARP query for the selected possible network address. If an ARP response is returned for the ARP query, then the selected possible network address is currently assigned to another device, and therefore not available, and the network protocol module of FIG. 2 selects another possible network address similar to the network address of the source of the packet. If no ARP response is returned for the ARP query, then the selected possible network address is not currently assigned to another device and the network protocol module accepts the possible network address as a network address for the device.

If the originally received packet was not an ARP query, then the network protocol module (190) of FIG. 2 is further capable of sending an ARP query for the source of the packet and if a response is returned, then the network protocol module is capable of selecting a possible network address similar to a network address of the source of the packet. If no response is returned, then the network protocol module is capable of selecting a possible network address similar to a destination network address of the packet. The network protocol module is also capable of determining whether the possible network address is currently assigned to another device by sending an ARP query for the selected possible network address and selecting another possible network address if an ARP response is returned for the ARP query for the selected possible network address. If no ARP response is returned for the ARP query for the selected possible network address, the network protocol module (190) of FIG. 2 is also capable of accepting the possible network address as a network address for the device (152).

The network protocol module of FIG. 2 is further capable of automatic configuration of the device by identifying the network address of a gateway by receiving a plurality of packets and determining a link layer address for the gateway in dependence upon the plurality of packets. The network protocol module of FIG. 2 is also capable of determining a network address for the gateway in dependence upon the link layer address for the gateway.

The exemplary computer (152) of FIG. 2 includes non-volatile computer memory (166) coupled through a system bus (160) to processor (156) and to other components of the computer. Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The exemplary computer (152) of FIG. 2 includes a communications adapter (167) for implementing connections for data communications (184), including connections through networks, to other computers (182), including servers, clients, and others as will occur to those of skill in the art. Communications adapters implement the hardware level of connections for data communications through which local devices and remote devices or servers send data communications directly to one another and through networks. Examples of communications adapters useful for automatic network configuration according to embodiments of the present invention include modems for wired dial-up connections, Ethernet (IEEE 802.3) adapters for wired LAN connections, and 802.11b adapters for wireless LAN connections.

The exemplary computer of FIG. 2 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

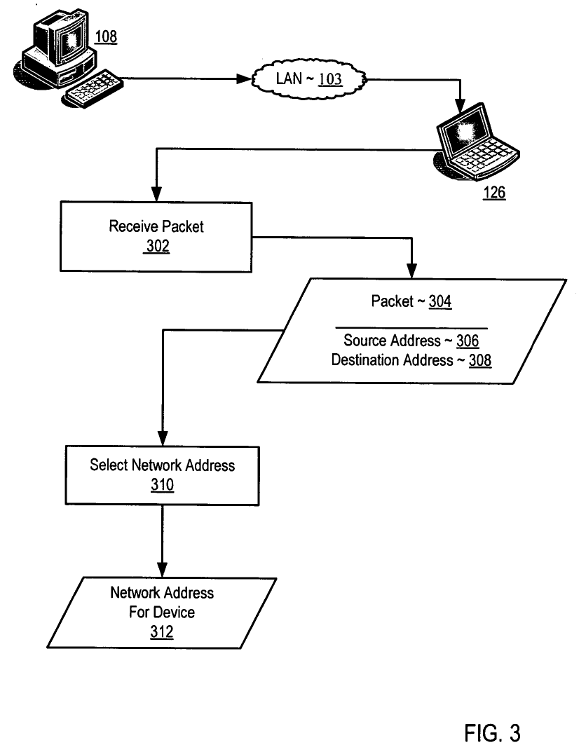

For further explanation, FIG. 3 sets forth a flow chart illustrating an exemplary method for automatic network configuration of a device (126). The method of FIG. 3 includes receiving (302), in a device (126) to be configured, a packet (304). In the method of FIG. 3, the packet (304) includes a source address (306) identifying the network address of the source of the packet. That is, the source address (306) identifies the network address of the sender of the packet. The exemplary packet (304) of FIG. 3 also includes a destination address (308) identifying the network address of the intended recipient of the packet.

As discussed above, the packet may be an ARP query sent by a device on the LAN (103) that is broadcast to all the devices on the LAN, or the packet may be a packet intended for the device on the LAN received by a gateway and broadcast to all the devices on the LAN. As discussed above, an address resolution protocol (“ARP”) query is a message broadcast to all the devices on a LAN for which a router or other device on the LAN seeks a corresponding link layer address. That is, all devices on the LAN are sent a link layer packet asking for their link layer addresses. The packet includes the sought network layer address. All devices on the LAN discard the ARP query except for the device whose network address matches the network address in the query. The device sends whose network address matches the network address in the query its link layer address to the requesting device.

The method of FIG. 3 also includes selecting (310), by the device (126) to be configured, a network address (312) in dependence upon a network address (306, 308) of the packet (304). As will be shown in more detail below, selecting (310), by the device (126) to be configured, a network address (312) in dependence upon a network address (306, 308) of the packet (304) may be carried out in a number of ways depending upon whether the packet (304) is an ARP query or whether the packet is a packet intended for another device on the LAN upon which the device to be configured is installed.

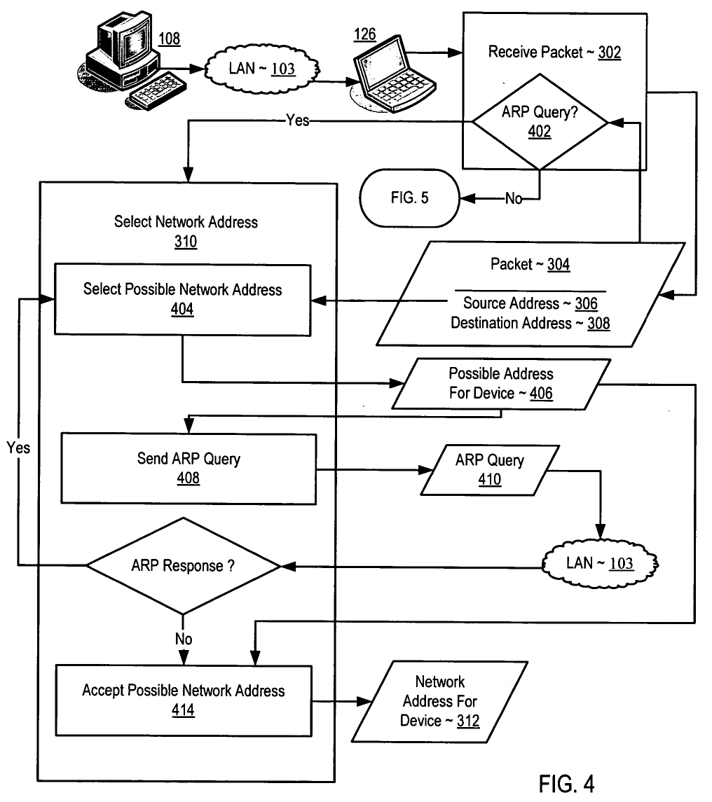

For further explanation, FIG. 4 sets forth a flow chart illustrating an exemplary method for automatic network configuration of a device wherein receiving (302), in a device to be configured, a packet (304) further comprises determining (402) whether the received packet (304) is an ARP query. If the received packet is an ARP query, selecting (310), by the device to be configured, a network address (312) in dependence upon a network address of the packet according to the method of FIG. 4 includes selecting (404) a possible network address (406) similar to the network address (306) of the source of the packet (304).

Selecting (404) a possible network address (406) similar to the network address (306) of the source of the packet (304) typically includes selecting a network address having the same subnet as the source of the packet. In typical embodiments, devices on the same LAN will be assigned network addresses having the same subnet or common address component. On TCP/IP networks, subnets are defined as all devices whose IP addresses have the same prefix. For example, all devices with IP addresses that start with 100.100.100. are part of the same subnet. Therefore, automatic network configuration according to the method of FIG. 4 advantageously identifies another device on the LAN and selects a possible network address for the device to be configured that is similar to the network address of the other identified device on the LAN.

The possible network address selected may in fact already be in use by another device on the LAN. That is, the possible network address may already be assigned to another device. To determine whether the selected possible network address is in fact available for use by the device to be configured, the method of FIG. 4 includes sending (408) an ARP query (410) for the selected possible network address (406). If an ARP response is returned for the ARP query, then the selected possible network address is currently assigned to another device, and the method of FIG. 4 includes selecting (404) another possible network address similar to the network address of the source of the packet. In the method of FIG. 4, selecting possible network addresses and sending ARP queries for the selected possible network addresses continues until no ARP response to the ARP query is received.

If no ARP response is returned for the ARP query, then the possible network address is available for use by the device to be configured and the method of FIG. 4 includes accepting (414) the possible network address (406) as a network address (312) for the device (126). Accepting (414) the possible network address (406) as a network address (312) for the device (126) is typically storing the accepted network address as a configuration parameter for data communications for the device.

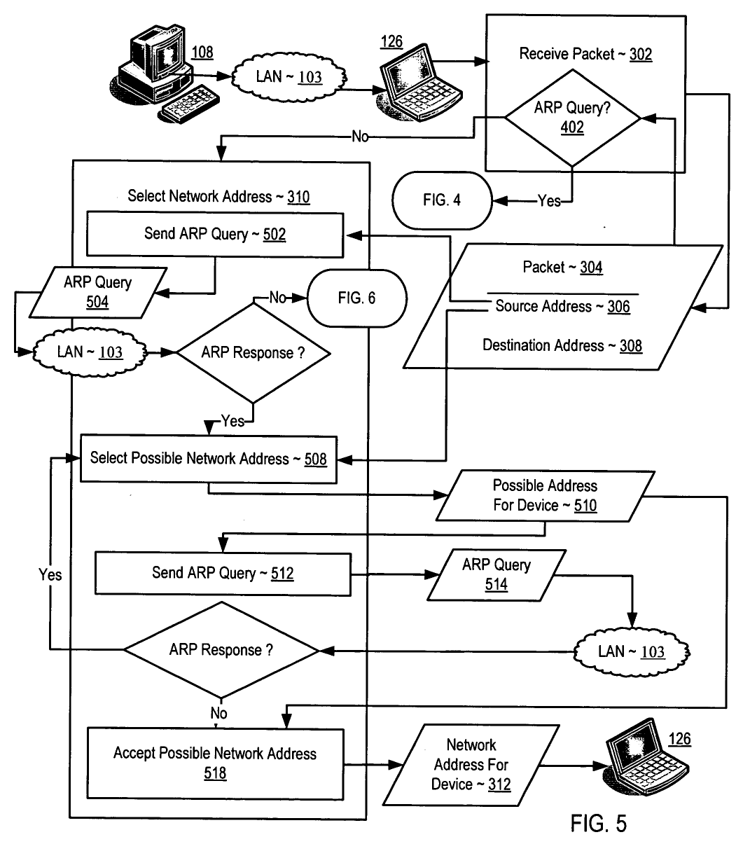

The operation of the method of FIG. 4 is contingent upon determining (402) that the originally received packet (304) is an ARP query. For further explanation, the method of FIG. 5 sets forth a flow chart illustrating an exemplary method for automatic network configuration of a device that operates when the originally received packet (304) is not an ARP query. In the method of FIG. 5 therefore, receiving (302), in a device to be configured, a packet (304) includes determining (402) that the received packet is not an ARP query.

In the method of FIG. 5, selecting (310), by the device to be configured, a network address (312) in dependence upon a network address of the packet includes sending (502) an ARP query (504) for the source of the packet (304). If a response is returned to the ARP query for the source of the packet, then the method of FIG. 5 includes selecting (508) a possible network address (510) similar to a network address (306) of the source of the packet (304). As discussed above, selecting (508) a possible network address (510) similar to a network address (306) of the source of the packet (304) typically includes selecting a network address having the same subnet as the source of the packet.

As described above, the possible network address selected may in fact already be in use by another device on the LAN. To determine whether the selected possible network address is in fact available for use by the device to be configured, the method of FIG. 5 includes sending (512) an ARP query (514) for the selected possible network address (510). If an ARP response is returned for the ARP query for the selected possible network address then the selected possible network address is already assigned to another device and the method of FIG. 5 includes selecting (508) another possible network address similar to the network address (306) of the source of the packet (304). In the method of FIG. 5, selecting possible network addresses and sending ARP queries for the selected possible network addresses continues until no ARP response to the ARP query is received.

If no ARP response is returned for the ARP query for the selected possible network address, then the selected possible network address is not currently assigned to another device on the LAN. The method of FIG. 5 therefore includes accepting (518) the possible network address (510) as a network address (312) for the device (126). Accepting (518) the possible network address (510) as a network address (312) for the device (126) is typically carried out by storing the possible network address as a configuration parameter for data communications for the device

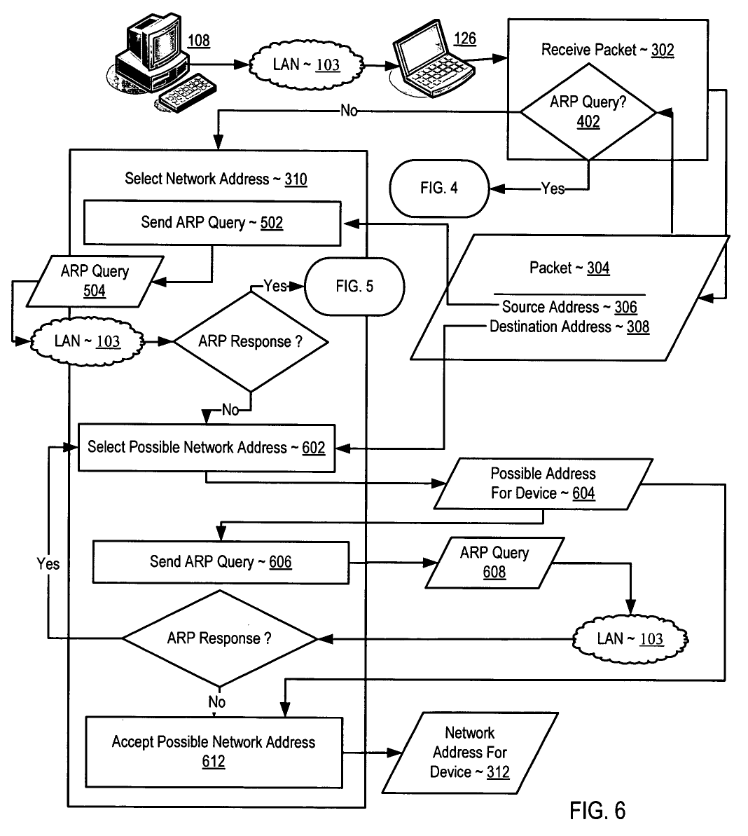

The operation of the method of FIG. 5 is contingent upon receiving a response to the ARP query for the source of the packet. FIG. 6 therefore sets forth a flow chart illustrating an exemplary method for automatic network configuration of a device when no response is received for the ARP query for the source of the packet. When no response is received for the ARP query for the source of the packet, the method of FIG. 6 includes selecting (602) a possible network address (604) similar to a network address (308) of the destination of the packet (304). As with selecting other possible network addresses, selecting (602) a possible network address (604) similar to a network address (308) of the destination of the packet (304) typically includes selecting a possible network address having the same subnet as the destination address of the packet.

As described above, the selected possible network address may in fact already be in use by another device on the LAN. To determine whether the selected possible network address is in fact available for use by the device to be configured, the method of FIG. 6 includes sending (606) an ARP query (608) for the selected possible network address (604) to determine whether the selected possible network address is already assigned to another device. If an ARP response is returned for the ARP query for the possible network address, then the possible network address is already assigned to another device and the method of FIG. 6 includes selecting (602) another possible network address similar to the network address (308) of the destination of the packet (304). In the method of FIG. 6, selecting (602) possible network addresses (604) similar to a network address (308) of the destination of the packet (304) and sending (606) ARP queries (608) for the selected possible network addresses (604) continues until no ARP response is returned for the ARP query.

If no ARP response is returned for the ARP query for the selected possible network address, then the possible network address is not currently assigned to another device and the method of FIG. 6 includes accepting (612) the possible network address (604) as a network address (312) for the device (126). Accepting (612) the possible network address (604) as a network address (312) for the device (126) is typically carried out by storing the possible network address as a configuration parameter for data communications for the device.

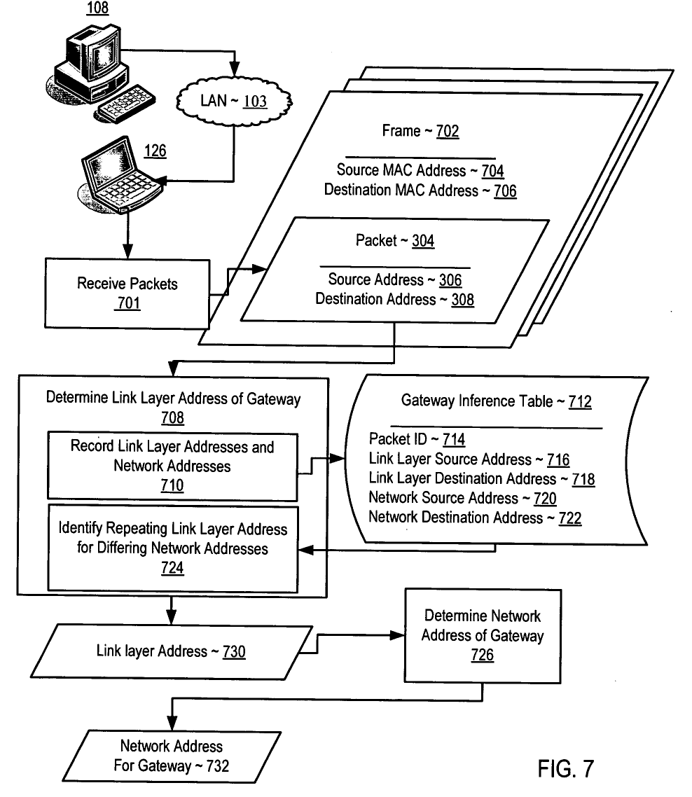

As discussed above, devices are often configured with the network address of the gateway to facilitate sending packets outside the LAN. For further explanation, FIG. 7 sets forth an exemplary method for automatic network configuration that provides the network address of the gateway. The method of FIG. 7 includes receiving (701) a plurality of packets (304) and determining (708) a link layer address (730) for a gateway in dependence upon the plurality of packets (304). In the method of FIG. 7, receiving (701) a plurality of packets (304) typically includes receiving a plurality of packets encapsulated in link layer frames (702) that are intended for other devices on the LAN.

When a gateway on the LAN is operating as a ‘hub’, all traffic on the LAN is broadcast to all the devices on the LAN. In typical operation, however, a link layer frame is not passed to the network layer module unless the packet is intended for the device. Instead, the frame not intended for the device is dropped. In the method of FIG. 7, however, all link layer frames (702) are passed to the network module. Conventional Ethernet cards are capable of being placed in ‘promiscuous’ mode which instructs the Ethernet card to pass all packets encapsulated in link layer frames to the network module.

In method of FIG. 7, determining (708) a link layer address (730) for a gateway in dependence upon the plurality of packets (304) includes recording (710) the link layer address and the network addresses of the packets in a gateway inference table (712). In typical embodiments each packet (304) is encapsulated in a link-layer frame (702) that identifies the source link layer address (704) and a destination link layer address (706). Recording (710) the link layer address and the network addresses of the packets in a gateway inference table (712) typically includes retrieving the source link layer address (704) and the destination link layer address (706) from the frame encapsulating the packet (304) and retrieving the source network address (306) and the destination network address (308) from the packet (304) and recording (710) the retrieved addresses in a data structure such as the gateway inference table (712) of FIG. 7.

The gateway inference table (712) of FIG. 7 is a data structure that includes source and destination network addresses and source and destination link layer addresses of packets received in the device to be configured that is used to infer the link layer address of the gateway. The gateway inference table (712) of FIG. 7 includes a packet ID field (714) identifying the packet received in the device to be configured. The gateway inference table (712) of FIG. 7 includes a link layer source address field (716) that identifies the link layer address of the source of the packet. The gateway inference table (712) of FIG. 7 includes a link layer destination address field (718) that identifies the link layer address of the destination of the packet. The gateway inference table (712) of FIG. 7 includes a network source address field (720) that identifies the network address of the source of the packet. The gateway inference table (712) of FIG. 7 includes a network destination address field (722) that identifies the network address of the destination of the packet.

In the method of FIG. 7, determining (708) a link layer address (730) for a gateway in dependence upon the plurality of packets (304) includes identifying (724) more than one packet having the same link layer addresses for either the source or destination of the packet, but having differing network addresses recorded for the source or destination. That is, identifying that a single link layer address is receiving or sending packets for a plurality of network layer addresses. In the method of FIG. 7, the repeating link layer address is determined to be the link layer address of the gateway.

The method of FIG. 7 also includes determining (726) a network address (732) for a gateway in dependence upon the link layer address (730) for the gateway. Determining (726) a network address (732) for a gateway in dependence upon the link layer address (730) for the gateway may be carried out in a number of ways. One way of determining (726) a network address (732) for a gateway in dependence upon the link layer address (730) for the gateway is carried out by identifying a record in the device's ARP cache having the link layer address of the gateway and retrieving from the identified record the network address of the gateway. To save time in link layer address resolution, devices often store recently resolved network addresses in association with their corresponding link layer addresses in an ‘ARP cache.’ An example of an ARP cache is shown in Table 1:

TABLE 1
Exemplary ARP Cache

| Network Layer Address | Link Layer Address | Type |
|---|---|---|
| 199.199.40.1 | 00 00 0c 1a eb c5 | Dynamic |
| 199.199.40.124 | 00 dd 01 07 57 15 | Dynamic |
| 10.57.10.32 | 00 60 8c 0e 6c 6a | Static |

Table 1 associates network layer addresses and link layer addresses in two entry types, dynamic and static. Static ARP cache entries are hand-entered and remain in the cache. Dynamic entries store ‘learned addresses’ entered automatically by the device in response to ARP queries, for example, and dynamic entries are ‘aged’ for an ‘aging time.’ That is, dynamic ARP cache entries time out according to the cache's aging time and are then deleted from the ARP cache. Typical aging times range from a few seconds to a few minutes or more. Determining (726) a network address (732) for a gateway in dependence upon the link layer address (730) for the gateway may be carried out by identifying a record in an ARP cache having the link layer address of the gateway and retrieving from the identified record the network address of the gateway.

Another way of determining (726) a network address (732) for a gateway in dependence upon the link layer address (730) for the gateway includes monitoring ARP replies intended for other computers on the network and identifying an ARP reply having the link layer address of the gateway. The network address of the gateway is then retrieved from the identified ARP reply.

Still another way of determining (726) a network address (732) for a gateway in dependence upon the link layer address (730) for the gateway may be carried out by monitoring packets intended for other computers and identifying a packet encapsulated in a frame having a source link layer address matching the link layer address of the gateway. Having identified a frame having a source link layer address matching the gateway, determining (726) a network address (732) for a gateway includes sending an ARP query for the source network address of the packet encapsulated in the frame. If an ARP response is received having a link layer address that matches the link layer address of the gateway, then the source network address is determined to be the network address of the gateway.

Still another way of determining (726) a network address (732) for a gateway in dependence upon the link layer address (730) for the gateway may be carried out by monitoring packets intended for other computers and identifying a packet encapsulated in a frame having a destination link layer address matching the link layer address of the gateway. Having identified a frame having a destination link layer address matching the gateway, determining (726) a network address (732) for a gateway includes sending an ARP query for the destination network address of the packet encapsulated in the frame. If an ARP response is received having a link layer address that matches the link layer address of the gateway, then the destination network address of the packet is determined to be the network address of the gateway.

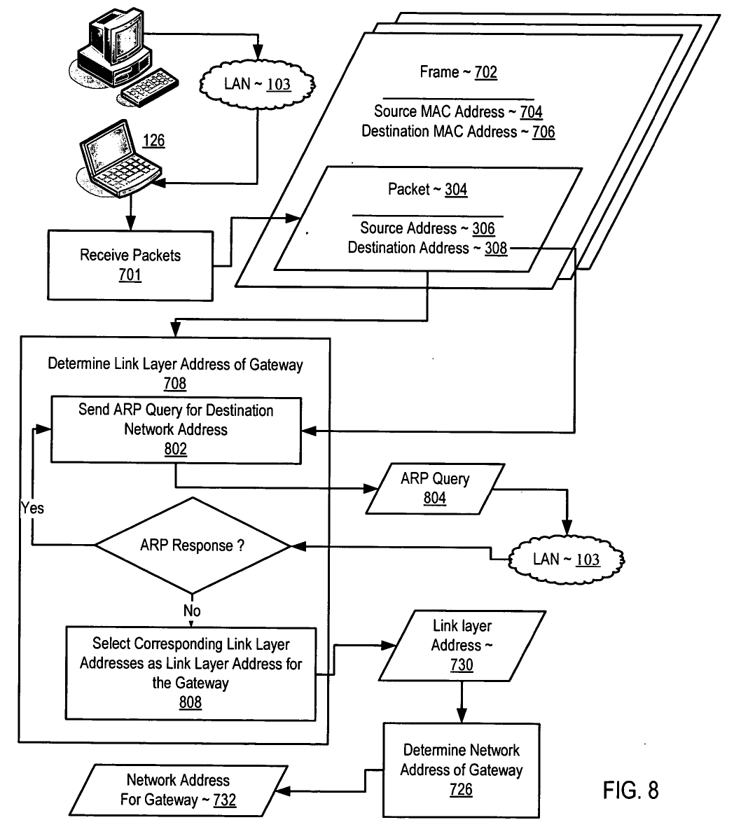

In the method of FIG. 7, the link layer address of the gateway is determined by comparing source and destination link layer and network layer addresses for packets received in the device to be configured. Another way of determining the link layer address (730) of the gateway may be carried out by use of the method of FIG. 8. FIG. 8 sets forth a flow chart illustrating an exemplary method for automatic network configuration of a device that includes receiving (701) a plurality of packets (304) and determining (708) a link layer address (730) for a gateway in dependence upon the plurality of packets (304). In the method of FIG. 8, determining (708) a link layer address (730) for a gateway in dependence upon the plurality of packets (304) is carried out by sending (802) an ARP query (804) for the destination network address (308) of the packet (304). In the method of FIG. 8, if no ARP response is received for the ARP query (804), then the link layer destination address (706) corresponding to the destination network address (308) is determined to be the link layer address of the gateway. If a response is received for the destination address, then the method of FIG. 8 continues by sending another ARP query for another network destination address for another packet. Sending ARP queries for destination network addresses for different packets continues in the method of FIG. 8 until no ARP response is received thereby identifying the link layer address of the gateway.

The method of FIG. 8 also includes determining (726) a network address (732) for a gateway in dependence upon the link layer address (730) for the gateway. Determining (726) a network address (732) for a gateway in dependence upon the link layer address (730) for the gateway may be carried out in a number of ways as discussed above with reference to FIG. 7. Such ways include:
identifying a record in an ARP cache having the link layer address of the gateway and retrieving from the identified record the network address of the gateway;
monitoring ARP replies intended for other computers on the network, identifying an ARP reply having the link layer address of the gateway, and retrieving the network address of the gateway from the ARP reply;
monitoring packets intended for other computers, identifying a packet encapsulated in a frame having a source link layer address matching the link layer address of the gateway or a destination link layer address matching the gateway, and sending an ARP query for the corresponding source network address of the packet encapsulated in the frame or sending an ARP query for the corresponding destination network address of the packet encapsulated in the frame;
   as well as other ways of determining the network address of the gateway as will occur to those of skill in the art.

Exemplary embodiments of the present invention are described largely in the context of fully functional computer systems for automatic network configuration. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets and networks that communicate with the Internet Protocol and the World Wide Web. Persons skilled in the art will recognize that any computer system having suitable programming means will be capable of executing the steps of the method of the invention as embodied in a program product. Persons skilled in the art will recognize that, although most of the exemplary embodiments described in this specification are oriented to software installed and executing on computer hardware, nevertheless, alternative embodiments implemented as firmware or as hardware are well within the scope of the present invention.

Automatic network configuration according to embodiments of the present invention advantageously provides a vehicle for configuration of a device without system administrator intervention that is dependent upon actual network traffic. Furthermore, automatic network configuration of the present invention may coexist with conventional static configurations. For example, once the device is automatically configured, a system administrator can still create a static configuration for the device. The system administrator can be notified of the automatic configuration through a display, such as an LCD, installed on the device, or the device can send out a broadcast packet that a configuration program on the system administrator's machine receives. The administrator can then connect to the device via the network and statically configure the device.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for automatic network configuration of a device, the method comprising:
receiving, in a device to be configured, a packet; and
selecting, by the device to be configured, a network address in dependence upon a network address of the packet.

2. The method of claim 1 wherein:
receiving, in a device to be configured, a packet further comprises determining whether the received packet is an ARP query; and
if the received packet is an ARP query, selecting, by the device to be configured, a network address in dependence upon a network address of the packet further comprises:
selecting a possible network address similar to the network address of the source of the packet;
sending an ARP query for the selected possible network address; and
if an ARP response is returned for the ARP query, selecting another possible network address similar to the network address of the source of the packet; and
if no ARP response is returned for the ARP query; accepting the possible network address as a network address for the device.

3. The method of claim 1 wherein:
receiving, in a device to be configured, a packet further comprises determining whether the received packet is an ARP query; and
if the received packet is not an ARP query, selecting, by the device to be configured, a network address in dependence upon a network address of the packet further comprises sending an ARP query for the source of the packet.

4. The method of claim 3 further comprising:
selecting a possible network address similar to a network address of the source of the packet if a response is returned to the ARP query for the source of the packet;
sending an ARP query for the selected possible network address;
if an ARP response is returned for the ARP query for the selected possible network address, selecting another possible network address similar to the network address of the source of the packet; and
if no ARP response is returned for the ARP query for the selected possible network address, accepting the possible network address as a network address for the device.

5. The method of claim 3 further comprising:
selecting a possible network address similar to a network address of the destination of the packet if no response is returned to the ARP query for the source of the packet;
sending an ARP query for the selected possible network address;
if an ARP response is returned for the ARP query for the possible network address, selecting another possible network address similar to the network address of the destination of the packet; and
if no ARP response is returned for the ARP query for the selected possible network address, accepting the possible network address as a network address for the device.

6. The method of claim 1 further comprising:
receiving a plurality of packets; and
determining a link layer address for a gateway in dependence upon the plurality of packets; and
determining a network address for a gateway in dependence upon the link layer address for the gateway.

7. A apparatus for automatic network configuration of a device, the apparatus comprising:
a computer processor;
a computer memory coupled for data transfer to the process, the computer memory having disposed within it computer program instructions comprising:
a network protocol module capable of receiving a packet and selecting a network address in dependence upon a network address of the packet.

8. The apparatus of claim 7 wherein the network protocol module also comprises an ARP module and the network protocol module is further capable of:
determining whether the received packet is an ARP query; and
if the received packet is an ARP query, the network protocol module is capable of:
selecting a possible network address similar to the network address of the source of the packet;
sending an ARP query for the selected possible network address;
selecting another possible network address similar to the network address of the source of the packet if an ARP response is returned for the ARP query; and
accepting the possible network address as a network address for the device if no ARP response is returned for the ARP query.

9. The apparatus of claim 7 wherein the network protocol module also comprises an ARP module and the network protocol module is further capable of:
determining whether the received packet is an ARP query; and
sending an ARP query for the source of the packet if the received packet is not an ARP query.

10. The apparatus of claim 9 wherein the network protocol module is further capable of:
selecting a possible network address similar to a network address of the source of the packet if a response is returned to the ARP query for the source of the packet;
sending an ARP query for the selected possible network address;
selecting another possible network address similar to the network address of the source of the packet if an ARP response is returned for the ARP query for the selected possible network address; and
accepting the possible network address as a network address for the device if no ARP response is returned for the ARP query for the selected possible network address.

11. The apparatus of claim 9 wherein the network protocol module is further capable of:
selecting a possible network address similar to a network address of the destination of the packet if no response is returned to the ARP query for the source of the packet;
sending an ARP query for the selected possible network address;
selecting another possible network address similar to the network address of the destination of the packet if an ARP response is returned for the ARP query for the possible network address; and
accepting the possible network address as a network address for the device if no ARP response is returned for the ARP query for the selected possible network address.

12. The apparatus of claim 7 wherein the network protocol module is further capable of:
receiving a plurality of packets; and
determining a link layer address for a gateway in dependence upon the plurality of packets; and
determining a network address for a gateway in dependence upon the link layer address for the gateway.

13. A system for automatic network configuration of a device, the system comprising:
means for receiving a packet; and
means for selecting a network address in dependence upon a network address of the packet.

14. The system of claim 13 wherein:
means for receiving a packet further comprises means for determining whether the received packet is an ARP query; and
means for selecting a network address in dependence upon a network address of the packet further comprises:
means for selecting a possible network address similar to the network address of the source of the packet;
means for sending an ARP query for the selected possible network address;
means for selecting another possible network address similar to the network address of the source of the packet if an ARP response is returned for the ARP query; and
means for accepting the possible network address as a network address for the device if no ARP response is returned for the ARP query.

15. The system of claim 13 wherein:
means for receiving a packet further comprises means for determining whether the received packet is an ARP query; and
means for selecting a network address in dependence upon a network address of the packet further comprises means for sending an ARP query for the source of the packet.

16. The system of claim 15 further comprising:
means for selecting a possible network address similar to a network address of the source of the packet if a response is returned to the ARP query for the source of the packet;
means for sending an ARP query for the selected possible network address;
means for selecting another possible network address similar to the network address of the source of the packet if an ARP response is returned for the ARP query for the selected possible network address; and
means for accepting the possible network address as a network address for the device if no ARP response is returned for the ARP query for the selected possible network address.

17. The system of claim 15 further comprising:
means for selecting a possible network address similar to a network address of the destination of the packet if no response is returned to the ARP query for the source of the packet;
means for sending an ARP query for the selected possible network address;
means for selecting another possible network address similar to the network address of the destination of the packet if an ARP response is returned for the ARP query for the possible network address; and
means for accepting the possible network address as a network address for the device if no ARP response is returned for the ARP query for the selected possible network address.

18. The system of claim 13 further comprising:
means for receiving a plurality of packets; and
means for determining a link layer address for a gateway in dependence upon the plurality of packets; and
means for determining a network address for a gateway in dependence upon the link layer address for the gateway.

19. A computer program product for automatic network configuration of a device, the computer program product disposed upon a signal bearing medium, the computer program product comprising:
computer program instructions that receive a packet; and
computer program instructions that select a network address in dependence upon a network address of the packet.

20. The computer program product of claim 19 wherein:
computer program instructions that receive a packet further comprise computer program instructions that determine whether the received packet is an ARP query; and
computer program instructions that select a network address in dependence upon a network address of the packet further comprise:
computer program instructions that select a possible network address similar to the network address of the source of the packet;
computer program instructions that send an ARP query for the selected possible network address; and
computer program instructions that select another possible network address similar to the network address of the source of the packet if an ARP response is returned for the ARP query; and
computer program instructions that accept the possible network address as a network address for the device if no ARP response is returned for the ARP query.

21. The computer program product of claim 19 wherein:
computer program instructions that receive a packet further comprises computer program instructions that determine whether the received packet is an ARP query; and
computer program instructions that select a network address in dependence upon a network address of the packet further comprises computer program instructions that send an ARP query for the source of the packet.

22. The computer program product of claim 21 further comprising:
computer program instructions that select a possible network address similar to a network address of the source of the packet if a response is returned to the ARP query for the source of the packet;
computer program instructions that send an ARP query for the selected possible network address;
computer program instructions that select another possible network address similar to the network address of the source of the packet if an ARP response is returned for the ARP query for the selected possible network address; and
computer program instructions that accept the possible network address as a network address for the device if no ARP response is returned for the ARP query for the selected possible network address.

23. The computer program product of claim 21 further comprising:
computer program instructions that select a possible network address similar to a network address of the destination of the packet if no response is returned to the ARP query for the source of the packet;
computer program instructions that send an ARP query for the selected possible network address;
computer program instructions that select another possible network address similar to the network address of the destination of the packet if an ARP response is returned for the ARP query for the possible network address; and
computer program instructions that accept the possible network address as a network address for the device if no ARP response is returned for the ARP query for the selected possible network address.

24. The computer program product of claim 19 further comprising:
computer program instructions that receive a plurality of packets; and
computer program instructions that determine a link layer address for a gateway in dependence upon the plurality of packets; and
computer program instructions that determine a network address for a gateway in dependence upon the link layer address for the gateway.
